(19) United States
(12) Patent Application Publication
(10) Pub. No.: US 2009/0251477 A1
(43) Pub. Date: Oct. 8, 2009

(54) MEMORY SAVING DISPLAY DEVICE

(76) Inventors: Ying-Jie Su, Hsinchu City (TW); Po-Jui Huang, Hsinchu County (TW); Chung-Jr Jan, Taipei County (TW); Yu-Lin Cheng, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/175,449

(22) Filed: Jul. 17, 2008

(30) Foreign Application Priority Data
Apr. 2, 2008 (TW) 097111992

(51) Int. Cl. G09G 5/36

(52) U.S. Cl. 345/547

(57) ABSTRACT

A display device capable of saving memory storage used for an overdriving function includes a compression unit, a frame buffer, a decompression unit and a look-up table (LUT) unit. The compression unit includes a decimation filter and is used for compressing data of a received frame and reducing a size of the received frame, to generate a compression frame. The frame buffer is coupled to the compression unit and used for storing the compression frame. The decompression unit includes an interpolation filter and is used for decompressing data of the compression frame outputted by the frame buffer and reducing a size of the compression frame, to generate a decompression frame. The LUT unit is coupled to the decompression unit and used for comparing the decompression frame with a next received frame of the received frame to determine an overdriving voltage.

### BACKGROUND OF THE INVENTION

1. Field of the Invention

The present invention relates to a display device, and more particularly, to a display device capable of saving memory for overdriving.

2. Description of the Prior Art

Image displaying of a liquid crystal display (LCD) utilizes a driving voltage to change a twist angle of a liquid crystal molecule corresponding to a pixel, so as to adjust a light penetrating rate and related polarization for various levels of brightness display. However, the liquid crystal molecule is not so sensitive to the driving voltage, having insufficiently fast response to the driving voltage. Thus, residual images are liable to occurs in dynamic image displaying of the LCD compared with a CRT (Cathode ray tube) display.

Thus, the LCD of the prior art adopts an overdriving function to accelerate the twist speed of the liquid crystal molecule to overcome the residual image effect and also efficiently increase a frame rate. For example, if a pixel desires for brightness corresponding to a grayscale G1, the LCD without the overdriving function provides a driving voltage V1 to twist the liquid crystal molecule to an angle θ1. To accelerate the liquid crystal molecule, the LCD equipped with the overdriving function provides an overdriving voltage V2 greater than the driving voltage V1 as a temporary driving voltage at first and then provides the driving voltage V1 as a steady driving voltage. In addition, determination of the driving voltage magnitude also depends on an initial angle of the liquid crystal molecule when twisting. For example, when a pixel attempts to be displayed at the grayscale G1 from an initial grayscale G2, a corresponding overdriving voltage V3 provided by the LCD is different from the overdriving voltage for a transition from a grayscale G3 to G1. Thus, the LCD manufacturer establishes a look-up table in the overdriving system to assign appropriate overdriving voltages for different grayscale differences.

The LCD has to obtain pixel data of two consecutive frames to calculate the grayscale differences for each pixel. Thus, the LCD employs a frame buffer in the overdriving system to store a current frame for comparing with an upcoming frame. In general, the frame data is compressed before being stored to save memory size of the frame buffer. The compressed frame data is decompressed when the grayscale differences are calculated.

In the prior art, a common way to compress the frame data is bit truncation, which discards part of data bits of every pixel in frame compression and pads data bits of every pixel with the same number of bits as the discarded bits in frame decompression. For example, if each pixel of a frame is represented by 8 bits, two least significant bits of each pixel are discarded after compression is performed. Then, each compressed pixel having 6 bits is padded with two “0” bits when decompression is performed. However, bit truncation has a low compression rate and thereby sacrifices image quality of edges of the overdriven frames.

### SUMMARY OF THE INVENTION

The present invention therefore provides a display device capable of saving memory for overdriving.

The present invention discloses a display device capable of saving memory storage used for an overdriving function. The display device includes a compression unit, a frame buffer, a decompression unit and a look-up table (LUT) unit. The compression unit includes a decimation filter and is used for compressing data of a received frame and reducing a size of the received frame, to generate a compression frame. The frame buffer is coupled to the compression unit and used for storing the compression frame. The decompression unit includes an interpolation filter and is used for decompressing data of the compression frame outputted by the frame buffer and reducing a size of the compression frame, to generate a decompression frame. The LUT unit is coupled to the decompression unit and used for comparing the decompression frame with a next received frame of the received frame to determine an overdriving voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to an embodiment of the present invention.

FIG. 2 is a schematic diagram of the compression unit of FIG. 1 according to an embodiment of the present invention.

FIG. 3 is a schematic diagram of the decompression unit of FIG. 1 according to an embodiment of the present invention.

### DETAILED DESCRIPTION

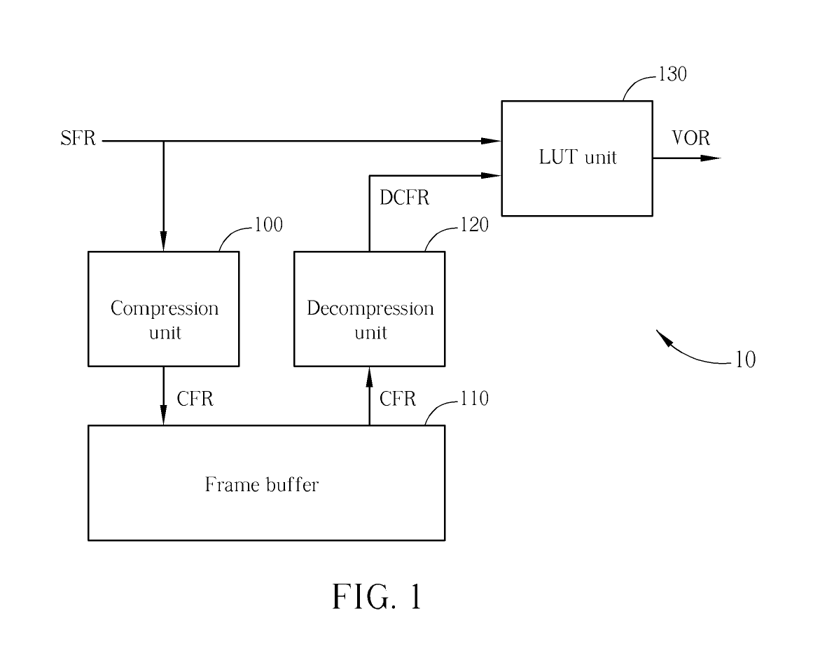

Please refer to FIG. 1, which is a schematic diagram of a display device 10 according to an embodiment of the present invention. The display device 10 is equipped with an overdriving function and includes a compression unit 100, a frame buffer 110, a decompression unit 120 and a look-up table (LUT) unit 130. The compression unit 100 is used for compressing data of a received frame SFR and reducing a size of the received frame SFR, to generate a compression frame CFR. Preferably, the received frame SFR includes grayscale data of each pixel. The frame buffer 110 is used for storing the compression frame CFR. The decompression unit 120 is used for decompressing data of the compression frame CFR outputted by the frame buffer and reducing a size of the compression frame CFR, so as to generate a decompression frame DCFR. The LUT unit 130 includes overdriving voltages corresponding to possible grayscale differences and is used for comparing the decompression frame DCFR with a next received frame of the received frame SFR to obtain grayscale differences of each pixel and thereby determines and outputs an overdriving voltage VOR.

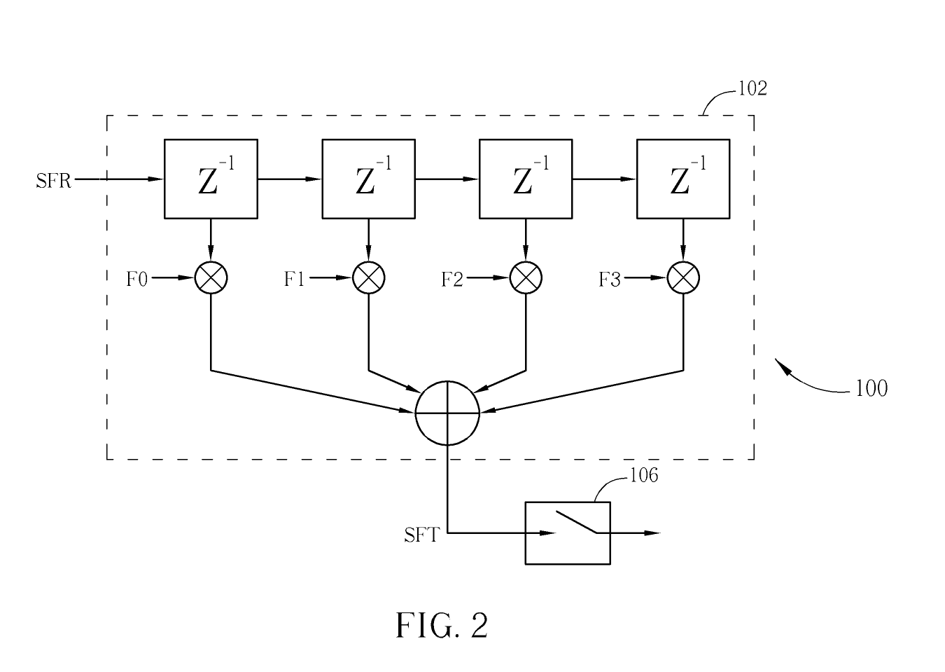

Please refer to FIG. 2, which is a schematic diagram of the compression unit 100 according to an embodiment of the present invention. The compression unit 100 includes a decimation filter 102 and a down-sampler 106. The decimation filter 102 is a four tap finite impulse response (FIR) filter, functioning as a low-pass filter. By adjusting frequency response values F0-F3, the decimation filter 102 filters out the data of the received frame SFR whose frequencies are higher than a predetermined frequency and thereby outputs a filtering signal SFT. The down-sampler 106 performs down-sampling to the filtering signal SFT according to a sampling rate to generate the compression frame CFR. By adjusting the sampling rate, the sampled filtering signal SFT affects size reduction of the compression frame CFR including horizontal and vertical dimensions. For example, the down-sampler 106 samples once every two consecutive sample points of the filtering signal SFT. In this situation, a horizontal size of the compression frame CFR is half the horizontal size of the received frame SFR. Take a received frame SFR having a horizontal size of 1024 sample points for another example. The down-sampler 106 consecutively takes 1024 sample points of the filtering signal SFT whenever 1024 consecutive sample points of the filtering signal SFT are directly outputted without being sampled. In this situation, the vertical size of the compression frame CFR is half the vertical size of the received frame SFR. Preferably, the down-sampler 106 is configured for reducing both the horizontal and vertical sizes of the received frame by a power of two.

Please note that the tap number of the decimation filter 102 can be modified according to compression requirement and thus the decimation filter 102 is used as an embodiment of the present invention. In practice, those skills in the art can select filters with more taps for a higher compression rate and so on.

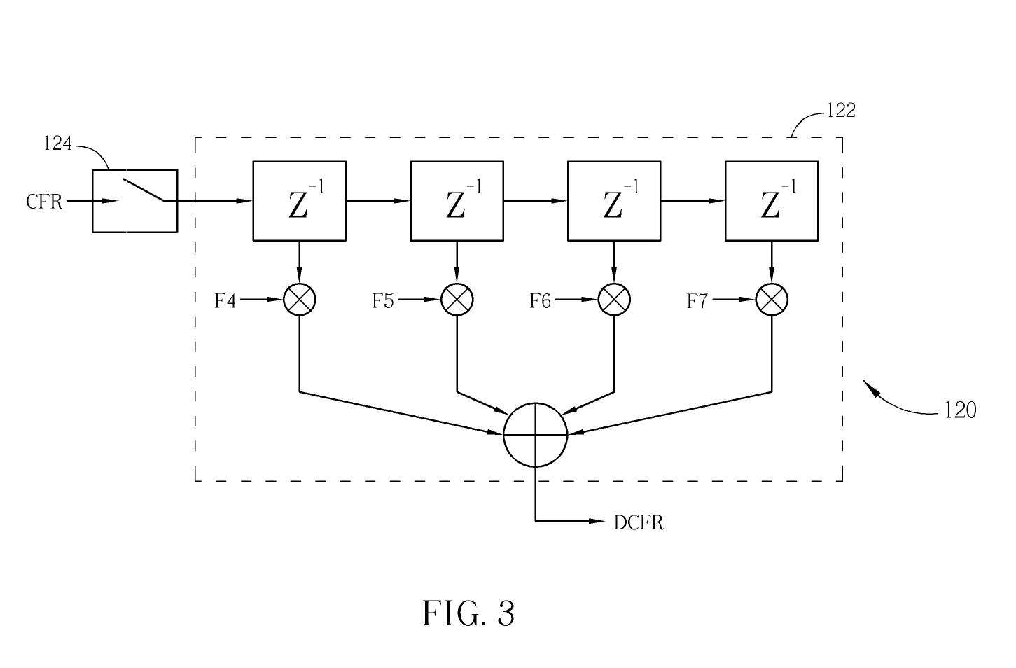

Please refer to FIG. 3, which is a schematic diagram of the decompression unit 120 according to an embodiment of the present invention. The decompression unit 120 includes an interpolation filter 122 and an up-sampler 124. The up-sampler 124 performs up-sampling to the compression frame CFR according to an over-sampling rate. Preferably, the over-sampling rate is a reciprocal of the sampling rate of the down-sampler 106. For example, when the down-sampler 106 outputs the compression frame CFR whose horizontal size is reduced by half compared to the received frame SFR, the up-sampler 124 samples twice for each sample point of the compression frame CFR so that the horizontal size of the compression frame CFR is enlarged to the horizontal size of the received frame SFR. The vertical size of the compression frame CFR can be recovered in a similar way, and detailed operation thereof is omitted herein. The interpolation filter 122 is a four tap FIR filter functioning to interpolate sample points outputted by the up-sampler 124 with frequency response values F4-F7 to generate the decompression frame DCFR whose frame size is identical with the frame size of the received frame SFR.

In the embodiment of the present invention, the compression unit 100 can compress the received frame SFR according to similarities between pixel data and pixel data, so as to reduce the storage memory size and also solve the problem of bad image quality of the frame edges in the prior art. For example, the compression unit 100 selects the frequency response values F0-F3 according to the pixel data similarities and adjusts the sampling rate to achieve a satisfactory compression rate.

In conclusion, the embodiments of the present invention not only efficiently reduce a memory size of the frame buffer in the overdriving system, but also maintain display quality of overdriven images.

Those skilled in the art will readily observe that numerous modifications and alterations of the device and method may be made while retaining the teachings of the invention.

What is claimed is:

1. A display device for saving memory storage used for an overdriving function, the display device comprising:
a compression unit comprising a decimation filter, for compressing data of a received frame and reducing a size of the received frame, to generate a compression frame;
a frame buffer coupled to the compression unit, for storing the compression frame;
a decompression unit comprising an interpolation filter, for decompressing data of the compression frame outputted by the frame buffer and enlarging a size of the compression frame, to generate a decompression frame; and
a look-up table unit coupled to the decompression unit, for comparing the decompression frame with a next received frame of the received frame to determine an overdriving voltage.

2. The display device of claim 1, wherein the decimation filter is a low-pass filter.

3. The display device of claim 1, wherein the decimation filter and the interpolation filter are a finite impulse response filter.

4. The display device of claim 1, wherein the compression unit reduces a horizontal size of the received frame.

5. The display device of claim 4, wherein the decompression unit enlarges a horizontal size of the compression frame to the horizontal size of the received frame.

6. The display device of claim 1, wherein the compression unit reduces a vertical size of the received frame.

7. The display device of claim 6, wherein the decompression unit enlarges a vertical size of the compression frame to the vertical size of the received frame.

8. The display device of claim 1, wherein the compression unit reduces the size of the received frame by a power of two.

9. The display device of claim 1, wherein the decompression unit enlarges the size of the received frame by a power of two.
